(19) United States
(12) Patent Application Publication
(10) Pub. No.: US 2024/0297691 A1
(43) Pub. Date: Sep. 5, 2024

(54) SYSTEMS AND METHODS FOR PREVENTING POWER IMBALANCE ACROSS ANTENNAS FOR DMRS TRANSMISSIONS

(71) Applicant: CommScope Technologies LLC, Claremont, NC (US)

(72) Inventors: Naveen Shanmugaraju, Bangalore (IN); Stuart D. Sandberg, Acton, MA (US)

(73) Assignee: CommScope Technologies LLC, Claremont, NC (US)

(21) Appl. No.: 18/595,151

(22) Filed: Mar. 4, 2024

(30) Foreign Application Priority Data
Mar. 4, 2023 (IN) 202341014642

(51) Int. Cl. H04B 7/0456

(52) U.S. Cl. CPC H04B 7/0482

(57) ABSTRACT

Systems and methods for preventing power imbalance across antennas for DMRS transmissions are provided herein. In one example, a method includes receiving an indication of a requested precoder from a user equipment, wherein the requested precoder is included in a codebook defined in a 3GPP specification. The method further includes applying a modified precoder corresponding to the requested precoder. The modified precoder is included in a modified codebook that is a modified version of the codebook defined in the 3GPP specification. The method further includes transmitting a double-symbol demodulation reference signal with the modified precoder to the user equipment.

### CROSS-REFERENCE TO RELATED APPLICATIONS

This application claims benefit of India Provisional Application Ser. No. 202341014642, filed on Mar. 4, 2023, and titled “SYSTEMS AND METHODS FOR PREVENTING POWER IMBALANCE ACROSS ANTENNAS FOR DMRS TRANSMISSIONS,” the contents of which are incorporated herein in their entirety.

### BACKGROUND

A centralized or cloud radio access network (C-RAN) is one way to implement base station functionality. Typically, for each cell (that is, for each physical cell identifier (PCI)) implemented by a C-RAN, one or more baseband unit (BBU) entities (also referred to herein simply as “BBUs”) interact with multiple radio units (also referred to here as “RUs,” “remote units,” “radio points,” or “RPs”) in order to provide wireless service to various items of user equipment (UEs). The one or more BBU entities may comprise a single entity (sometimes referred to as a “baseband controller” or simply a “baseband band unit” or “BBU”) that performs Layer-3, Layer-2, and some Layer-1 processing for the cell. The one or more BBU entities may also comprise multiple entities, for example, one or more central units (CU) entities that implement Layer-3 and non-time critical Layer-2 functions for the associated base station and one or more distributed units (DUs) that implement the time critical Layer-2 functions and at least some of the Layer-1 (also referred to as the Physical Layer) functions for the associated base station. Each CU can be further partitioned into one or more user-plane and control-plane entities that handle the user-plane and control-plane processing of the CU, respectively. Each such user-plane CU entity is also referred to as a “CU-UP,” and each such control-plane CU entity is also referred to as a “CU-CP.” In this example, each RU is configured to implement the radio frequency (RF) interface and the Physical Layer functions for the associated base station that are not implemented in the DU. The multiple RUs may be located remotely from each other (that is, the multiple RUs are not co-located) or collocated (for example, in instances where each RU processes different carriers or time slices), and the one or more BBU entities are communicatively coupled to the RUs over a fronthaul network.

### SUMMARY

In some aspects, a method is described herein. The method includes receiving an indication of a requested precoder from a user equipment, wherein the requested precoder is included in a codebook defined in a 3GPP specification. The method further includes applying a modified precoder corresponding to the requested precoder. The modified precoder is included in a modified codebook that is a modified version of the codebook defined in the 3GPP specification. The method further includes transmitting a double-symbol demodulation reference signal with the modified precoder to the user equipment.

In other aspects, a system is described herein. The system includes a base station configured to provide service to user equipment in a cell. The base station is configured to receive an indication of a requested precoder from a first user equipment in the cell, wherein the requested precoder is included in a codebook defined in a 3GPP specification. The base station is further configured to apply a modified precoder corresponding to the requested precoder to a double-symbol demodulation reference signal. The modified precoder is included in a modified codebook that is a modified version of the codebook defined in the 3GPP specification. The base station is further configured to transmit the double-symbol demodulation reference signal with the modified precoder to the first user equipment.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIGS. 1A-1C are block diagrams illustrating example radio access networks;

FIG. 2A illustrates the precoder, cover codes, DMRS after precoding, and transmit power of antennas for 4×2 MIMO when using an unmodified codebook;

FIG. 2B illustrates the precoder, cover codes, DMRS after precoding, and transmit power of antennas for 4×3 MIMO when using an unmodified codebook;

FIG. 2C illustrates the precoder, cover codes, DMRS after precoding, and transmit power of antennas for 4×4 MIMO when using an unmodified codebook;

FIG. 3 illustrates a graph of transmit power of antennas for DMRS transmissions;

FIG. 4A illustrates the precoder, cover codes, DMRS after precoding, and transmit power of antennas for 4×2 MIMO when using a modified codebook;

FIG. 4B illustrates the precoder, cover codes, DMRS after precoding, and transmit power of antennas for 4×3 MIMO when using a modified codebook; and

FIG. 4C illustrates the precoder, cover codes, DMRS after precoding, and transmit power of antennas for 4×4 MIMO when using a modified codebook; and

FIG. 5 illustrates a flow diagram of an example method for preventing power imbalance across antennas for DMRS transmissions.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be used and that logical, mechanical, and electrical changes may be made. Furthermore, the method presented in the drawing figures and the specification is not to be construed as limiting the order in which the individual acts may be performed. The following detailed description is, therefore, not to be taken in a limiting sense.

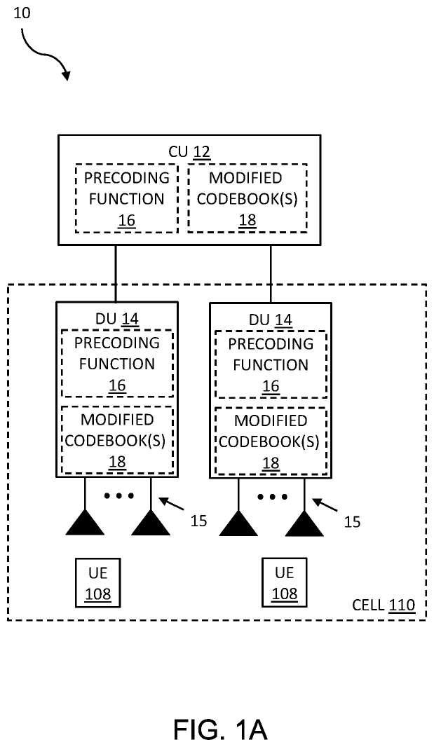

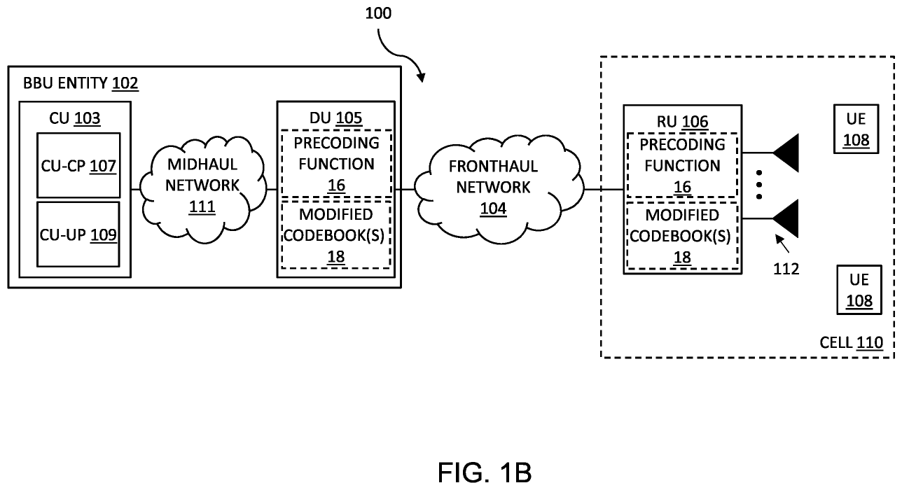

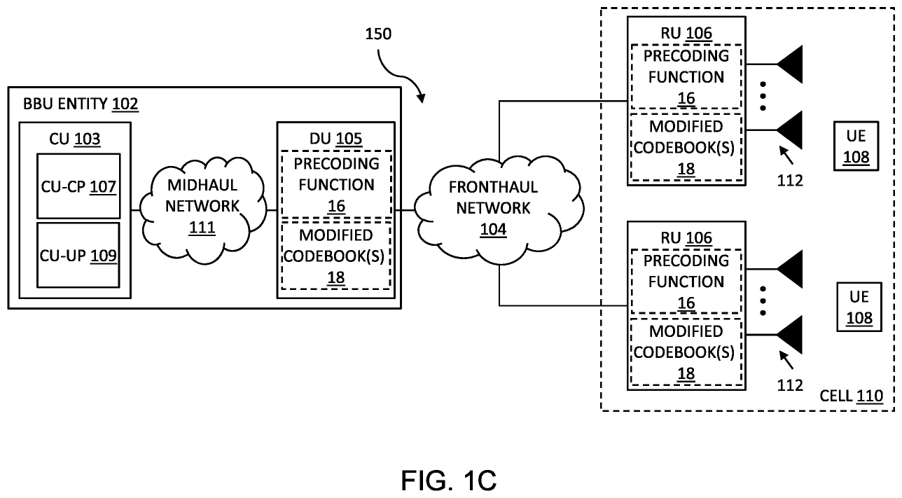

FIG. 1A is a block diagram illustrating an example base station 10 in which the techniques for preventing power imbalance across antennas for Demodulation Reference Signal (DMRS) transmissions described herein can be implemented.

In the example shown in FIG. 1A, the base station 10 is implemented as a Fifth Generation (5G) New Radio (NR) base station (also referred to as a “gNodeB” or “gNB”). In this example, the gNB 10 is partitioned into a central unit (CU) 12 and multiple distributed units (DUs) 14 providing service to UEs 108 in a cell 110. The 5G NR protocol stack includes different layers of functionality that can be split at different points such that the functionality can be performed in the CU or DU of the base station depending on the split. The different configurations of where the split point is located that defines where functionality in the 5G NR protocol stack is performed are referred to herein as “functional split options,” “split options,” or “splits.” In some examples, the CU 12 implements Layer-3 and non-time critical Layer-2 functions for the gNB 10, and the DUs 14 are configured to implement time critical Layer-2 functions, Layer-1 functions, and the Radio Frequency (RF) interface for the gNB 10. However, it should be understood that any functional split between the CU 12 and DUs 14 (for example, as discussed in 3rd Generation Partnership Project (3GPP) Technical Report (TR) 38.801) can be implemented for the gNB 10.

In some examples, the CU 12 can be further partitioned into one or more control-plane and user-plane entities that handle the control-plane and user-plane processing of the CU 12, respectively. Each such control-plane CU entity is also referred to as a “CU-CP,” and each such user-plane CU entity is also referred to as a “CU-UP.”

The DUs 14 are configured to implement the control-plane and user-plane Layer-2 functions not implemented by the CU 12 as well as the Layer-1 functions and radio frequency (RF) functions. The DUs 14 are located remotely from the CU 12. In the example shown in FIG. 1A, the DUs 14 are deployed in or near a physical location where radio coverage is to be provided in the cell 110. In this example, the DUs 14 include or are coupled to a set of antennas 15 via which downlink RF signals are radiated to UEs 108 and via which uplink RF signals transmitted by UEs 108 are received. In some examples, the set of antennas 15 includes two or four antennas. However, it should be understood that the set of antennas 15 can include two or more antennas 15. In one configuration (used, for example, in indoor deployments), each DU 14 is co-located with its respective set of antennas 15 and is remotely located from the CU 12 serving it. In another configuration (used, for example, in outdoor deployments), the antennas 15 for the DU 14 are deployed in a sectorized configuration (for example, mounted at the top of a tower or mast). In such a sectorized configuration, each DU 14 need not be co-located with the respective sets of antennas 15 and, for example, can be located at the base of the tower or mast structure, for example, and, possibly, co-located with its serving CU 12.

While the example shown in FIG. 1A shows a single CU 12 and two DUs 14 for the base station 10, it should be understood that this is an example and other numbers of CUs 12 and/or DUs 14 can also be used.

FIG. 1B is a block diagram illustrating another example base station 100 in which the techniques for preventing power imbalance across antennas for Demodulation Reference Signal (DMRS) transmissions described herein can be implemented. In the particular example shown in FIG. 1B, the base station 100 includes one or more baseband unit (BBU) entities 102 communicatively coupled to a RU 106 via a fronthaul network 104 and communicatively coupled to the core network 101 via a backhaul network 116. The base station 100 provides wireless service to various items of user equipment (UEs) 108 in a cell 110. Each BBU entity 102 can also be referred to simply as a “BBU.”

In the example shown in FIG. 1B, the one or more BBU entities 102 comprise one or more central units (CUs) 103 and one or more distributed units (DUs) 105. In some examples, each CU 103 is configured to implement Layer-3 and non-time critical Layer-2 functions for the associated base station 100, and each DU 105 is configured to implement the time critical Layer-2 functions and at least some of the Layer-1 (also referred to as the Physical Layer) functions for the associated base station 100. Each CU 103 can be further partitioned into one or more control-plane and user-plane entities 107, 109 that handle the control-plane and user-plane processing of the CU 103, respectively. Each such control-plane CU entity 107 is also referred to as a “CU-CP” 107, and each such user-plane CU entity 109 is also referred to as a “CU-UP” 109. In some examples, the DU 105 is configured to be coupled to the CU-CP 107 and CU-UP 109 over a midhaul network 111 (for example, a network that supports the Internet Protocol (IP)). Other configurations and examples can be implemented in other ways.

The RU 106 is configured to implement the control-plane and user-plane Layer-1 functions not implemented by the DU 105 as well as the radio frequency (RF) functions. The RU 106 is typically located remotely from the one or more BBU entities 102. In the example shown in FIG. 1B, the RU 106 is implemented as a physical network function (PNF) and is deployed in or near a physical location where radio coverage is to be provided in the cell 110. In the example shown in FIG. 1B, the RU 106 is communicatively coupled to the DU 105 using a fronthaul network 104. In some examples, the fronthaul network 104 is a switched Ethernet fronthaul network (for example, a switched Ethernet network that supports the Internet Protocol (IP)).

The RU 106 includes or is coupled to a set of antennas 112 via which downlink RF signals are radiated to UEs 108 and via which uplink RF signals transmitted by UEs 108 are received. In some examples, the set of antennas 112 includes two or four antennas. However, it should be understood that the set of antennas 112 can include two or more antennas 112. In one configuration (used, for example, in indoor deployments), the RU 106 is co-located with its respective set of antennas 112 and is remotely located from the one or more BBU entities 102 serving it. In another configuration (used, for example, in outdoor deployments), the antennas 112 for the RU 106 are deployed in a sectorized configuration (for example, mounted at the top of a tower or mast). In such a sectorized configuration, the RU 106 need not be co-located with the respective sets of antennas 112 and, for example, can be located at the base of the tower or mast structure, for example, and, possibly, co-located with its serving one or more BBU entities 102.

While the example shown in FIG. 1B shows a single CU-CP 107, a single CU-UP 109, a single DU 105, and a single RU 106 for the base station 100, it should be understood that this is an example and other numbers of BBU entities 102, components of the BBU entities 102, and/or other numbers of RUs 106 can also be used. Further, while a particular functional split between the CU 103, DU 105, and RU 106 is discussed above, it should be understood that any functional split between the CU 103, DU 105, and RU 106 can be implemented for the base station 100.

FIG. 1C is a block diagram illustrating an example base station 150 in which the techniques for preventing power imbalance across antennas for Demodulation Reference Signal (DMRS) transmissions described herein can be implemented. In the particular example shown in FIG. 1C, the base station 150 includes one or more BBU entities 102 communicatively coupled to multiple radio units RU 106 via a fronthaul network 104 and communicatively coupled to the core network 101 via a backhaul network 116. The base station 150 provides wireless service to various UEs 108 in a cell 110. Each BBU entity 102 can also be referred to simply as a “BBU.”

In the example shown in FIG. 1C, the one or more BBU entities 102 comprise one or more CUs 103 and one or more DUs 105. In some examples, each CU 103 is configured to implement Layer-3 and non-time critical Layer-2 functions for the associated base station 100, and each DU 105 is configured to implement the time critical Layer-2 functions and at least some of the Layer-1 (also referred to as the Physical Layer) functions for the associated base station 150. Each CU 103 can be further partitioned into one or more control-plane and user-plane entities 107, 109 that handle the control-plane and user-plane processing of the CU 103, respectively. Each such control-plane CU entity 107 is also referred to as a “CU-CP” 107, and each such user-plane CU entity 109 is also referred to as a “CU-UP” 109. In some examples, the DU 105 is configured to be coupled to the CU-CP 107 and CU-UP 109 over a midhaul network 111 (for example, a network that supports the Internet Protocol (IP)). Other configurations and examples can be implemented in other ways.

The RUs 106 are configured to implement the control-plane and user-plane Layer-1 functions not implemented by the DU 105 as well as the radio frequency (RF) functions. Each RU 106 is typically located remotely from the one or more BBU entities 102 and located remotely from other RUs 106. In the example shown in FIG. 1C, each RU 106 is implemented as a physical network function (PNF) and is deployed in or near a physical location where radio coverage is to be provided in the cell 110. In the example shown in FIG. 1C, the RUs 106 are communicatively coupled to the DU 105 using a fronthaul network 104. In some examples, the fronthaul network 104 is a switched Ethernet fronthaul network (for example, a switched Ethernet network that supports the Internet Protocol (IP)).

Each of the RUs 106 includes or is coupled to a respective set of antennas 112 via which downlink RF signals are radiated to UEs 108 and via which uplink RF signals transmitted by UEs 108 are received. In some examples, each set of antennas 112 includes two or four antennas. However, it should be understood that each set of antennas 112 can include two or more antennas 112. In one configuration (used, for example, in indoor deployments), each RU 106 is co-located with its respective set of antennas 112 and is remotely located from the one or more BBU entities 102 serving it and the other RUs 106. In another configuration (used, for example, in outdoor deployments), the sets of antennas 112 for the RUs 106 are deployed in a sectorized configuration (for example, mounted at the top of a tower or mast). In such a sectorized configuration, the RUs 106 need not be co-located with the respective sets of antennas 112 and, for example, can be located at the base of the tower or mast structure, for example, and, possibly, co-located with the serving one or more BBU entities 102. Other configurations can be used.

While the example shown in FIG. 1C shows a single CU-CP 107, a single CU-UP 109, a single DU 105, and two RUs 106 for the base station 150, it should be understood that this is an example and other numbers of BBU entities 102, components of the BBU entities 102, and/or other numbers of RUs 106 can also be used. Further, while a particular functional split between the CU 103, DU 105, and RUs 106 is discussed above, it should be understood that any functional split between the CU 103, DU 105, and RUs 106 can be implemented for the base station 150.

The base stations 10, 100, 150 that include the components shown in FIGS. 1A-1C can be implemented using a scalable cloud environment in which resources used to instantiate each type of entity can be scaled horizontally (that is, by increasing or decreasing the number of physical computers or other physical devices) and vertically (that is, by increasing or decreasing the “power” (for example, by increasing the amount of processing and/or memory resources) of a given physical computer or other physical device). The scalable cloud environment can be implemented in various ways. For example, the scalable cloud environment can be implemented using hardware virtualization, operating system virtualization, and application virtualization (also referred to as containerization) as well as various combinations of two or more of the preceding. The scalable cloud environment can be implemented in other ways. In some examples, the scalable cloud environment is implemented in a distributed manner. That is, the scalable cloud environment is implemented as a distributed scalable cloud environment comprising at least one central cloud, at least one edge cloud, and at least one radio cloud.

In some examples, one or more components of the base station 10, 100, 150 (for example, CU 12, 103, CU-CP 107, CU-UP 109, and/or DU 14, 105) are implemented as a software virtualized entities that are executed in a scalable cloud environment on a cloud worker node under the control of the cloud native software executing on that cloud worker node. In some such examples, the CU and DU are communicatively coupled and implemented as separate software virtualized entities. In some other examples, the CU and DU are implemented as a single virtualized entity executing on a single cloud worker node. In some examples, the at least one CU-CP and the at least one CU-UP can each be implemented as a single virtualized entity executing on the same cloud worker node or as a single virtualized entity executing on a different cloud worker node. However, it is to be understood that different configurations and examples can be implemented in other ways. For example, the CU can be implemented using multiple CU-UP VNFs and using multiple virtualized entities executing on one or more cloud worker nodes. Moreover, it is to be understood that the CU and DU can be implemented in the same cloud (for example, together in a radio cloud or in an edge cloud).

For 5G NR systems, the base station (for example, base station 10, 100, 150) is configured to transmit downlink Demodulation Reference Signals (DMRSs) to aid UEs 108 with radio channel estimation for demodulation of associated downlink physical channels. The specific design and mapping for downlink DMRS can be defined using the fields of the DMRS-DownlinkConfig information element (IE) as described in Section 6.3.2 of 3GPP Technical Specification (TS) 38.331 and discussed in Sections 7.4.1.1.1-7.4.1.1.2 of 3GPP TS 38.211. As discussed in Section 6.3.2 of 3GPP TS 38.331, the maximum number of OFDM symbols for downlink front-loaded DMRS is defined using the parameter maxLength, which can be set to “len1” for single-symbol DMRS or “len2” for double-symbol DMRS.

During operation, a UE 108 is configured to send a measurement report with a Precoding Matrix Indicator (PMI) that indicates a requested precoder of a codebook defined in Section 5.2.2.2 of 3GPP TS 38.214. Typically, a base station would estimate the channel quality based on the measurement report from the UE 108 and, while not mandatory, apply the requested precoder to DMRS and data based on the PMI when executing a precoding function 16. This results in the transmit power imbalance and other problems discussed herein.

As specified in 3GPP specifications (for example, TS 38.211, TS 38.212, and TS 38.214), a 4-antenna transmission for a DMRS code division multiplexing (CDM) group takes the form PC. P is a 4×L precoder matrix from the 5G codebook, L is the number of MIMO layers, and C is an L×4 matrix representing the orthonormal cover codes for the given CDM group.

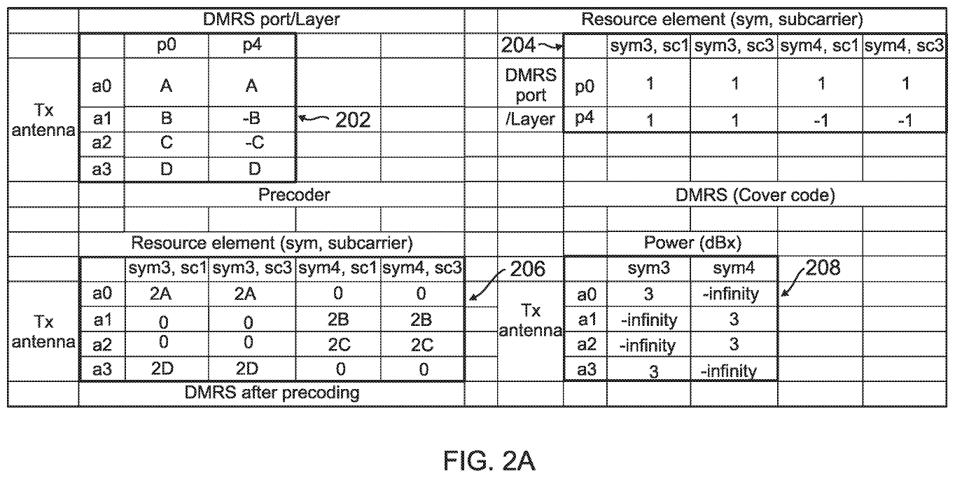

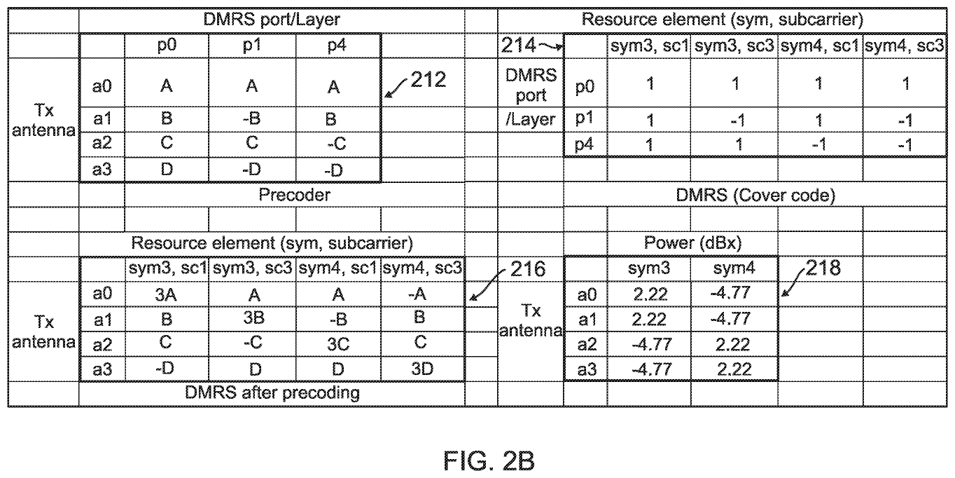

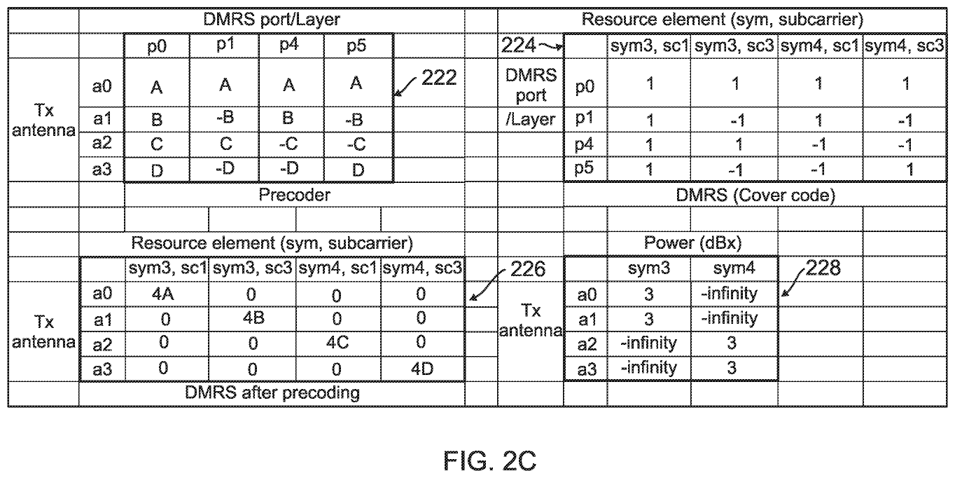

FIGS. 2A-2C illustrate the precoder matrix (P), DMRS cover codes (C), DMRS after precoding, and transmit power of antennas for example 4×L (L=2,3,4) MIMO systems using a codebook as defined in Section 5.2.2.2.1 of 3GPP TS 38.214.

FIG. 2A illustrates the precoder matrix 202, DMRS cover codes 204, DMRS after precoding 206, and transmit power of antennas 208 for an example 4×2 MIMO system using a codebook as defined in Section 5.2.2.2.1 of 3GPP TS 38.214. In the example shown in FIG. 2A, the form of the precoder matrix 202 is shown, and the letters A, B, C, and D in the precoder matrix 202 represent different values from a 2-layer codebook. The rows of the DMRS cover codes 204 are orthonormal. Columns 1 and 2 of the DMRS cover codes 204 are used for transmission in the first symbol of the double-symbol pair, and columns 3 and 4 of the DMRS cover codes 204 are used for transmission in the second symbol of the double-symbol pair. Columns 1 and 3 of the DMRS cover codes 204 are used for transmission in the first resource element, and columns 2 and 4 are used for transmission in the second resource element. The DMRS after precoding 206 represents the product of the precoder matrix 202 and the DMRS cover codes 204. As shown in the DMRS after precoding 206, columns 1 and 2 of the DMRS cover codes 204 are coherent with rows 1 and 4 of the precoder matrix 202 and orthogonal to rows 2 and 3 of the precoder matrix 202. This results in an increased transmit power of 3 dB for antenna 1 (a0) and antenna 4 (a3) and zero transmit power for antenna 2 (a1) and antenna 3 (a2) in symbol 3 as shown in the transmit power of antennas 208. Similarly, as shown in the DMRS after precoding 206, columns 3 and 4 of the DMRS cover codes 204 are coherent with rows 2 and 3 of the precoder matrix 202 and orthogonal to rows 1 and 4 of the precoder matrix 202. This results in an increased transmit power of 3 dB for antenna 2 (a1) and antenna 3 (a2) and zero transmit power for antenna 1 (a0) and antenna 4 (a3) in symbol 4 as shown in the transmit power of antennas 208.

FIG. 2B illustrates the precoder matrix 212, DMRS cover codes 214, DMRS after precoding 216, and transmit power of antennas 218 for an example 4×3 MIMO system using a codebook as defined in Section 5.2.2.2.1 of 3GPP TS 38.214. In the example shown in FIG. 2B, the form of the precoder matrix 212 is shown, and the letters A, B, C, and D in the precoder matrix 212 represent different values from a 3-layer codebook. The rows of the DMRS cover codes 214 are orthonormal. Columns 1 and 2 of the DMRS cover codes 214 are used for transmission in the first symbol of the double-symbol pair, and columns 3 and 4 of the DMRS cover codes 214 are used for transmission in the second symbol of the double-symbol pair. Columns 1 and 3 of the DMRS cover codes 214 are used for transmission in the first resource element, and columns 2 and 4 are used for transmission in the second resource element. The DMRS after precoding 216 represents the product of the precoder matrix 212 and the DMRS cover codes 214. As shown in the DMRS after precoding 216, columns 1 and 2 of the DMRS cover codes 214 are relatively coherent with rows 1 and 2 of the precoder matrix 212 and relatively incoherent with rows 3 and 4 of the precoder matrix 212. This results in an increased transmit power of 2.22 dB for antenna 1 (a0) and antenna 2 (a1) and a decreased transmit power of −4.77 dB for antenna 3 (a2) and antenna 4 (a3) in symbol 3 as shown in the transmit power of antennas 218. Similarly, as shown in the DMRS after precoding 216, columns 3 and 4 of the DMRS cover codes 214 are relatively coherent with rows 3 and 4 of the precoder matrix 212 and relatively incoherent with rows 1 and 2 of the precoder matrix 212. This results in an increased transmit power of 2.22 dB for antenna 3 (a2) and antenna 4 (a3) and a decreased transmit power of −4.77 dB for antenna 1 (a0) and antenna 2 (a1) in symbol 4 as shown in the transmit power of antennas 218.

FIG. 2C illustrates the precoder matrix 222, DMRS cover codes 224, DMRS after precoding 226, and transmit power of antennas 228 for an example 4×4 MIMO system using a codebook as defined in Section 5.2.2.2.1 of 3GPP TS 38.214. In the example shown in FIG. 2C, the form of the precoder matrix 222 is shown, and the letters A, B, C, and D in the precoder matrix 222 represent different values from a 4-layer codebook. The rows of the DMRS cover codes 224 are orthonormal. Columns 1 and 2 of the DMRS cover codes 224 are used for transmission in the first symbol of the double-symbol pair, and columns 3 and 4 of the DMRS cover codes 224 are used for transmission in the second symbol of the double-symbol pair. Columns 1 and 3 of the DMRS cover codes 224 are used for transmission in the first resource element, and columns 2 and 4 are used for transmission in the second resource element. The DMRS after precoding 226 represents the product of the precoder matrix 222 and the DMRS cover codes 224. As shown in the DMRS after precoding 226, columns 1 and 2 of the DMRS cover codes 224 are coherent with rows 1 and 2 of the precoder matrix 222 and orthogonal to rows 3 and 4 of the precoder matrix 222. This results in an increased transmit power of 3 dB for antenna 1 (a0) and antenna 2 (a1) and zero transmit power for antenna 3 (a2) and antenna 4 (a3) in symbol 3 as shown in the transmit power of antennas 228. Similarly, as shown in the DMRS after precoding 226, columns 3 and 4 of the DMRS cover codes 224 are coherent with rows 3 and 4 of the precoder matrix 222 and orthogonal to rows 1 and 2 of the precoder matrix 222. This results in an increased transmit power of 3 dB for antenna 3 (a2) and antenna 4 (a2) and zero transmit power for antenna 1 (a0) and antenna 2 (a1) in symbol 4 as shown in the transmit power of antennas 228.

According to the analysis from FIGS. 2A-2C, for 4×L (L=2,3,4) MIMO systems that utilize double-symbol DMRS configurations (for example, with maxLength set to “len2”), any precoding implemented using a precoder matrix in the 2-layer, 3-layer, and 4-layer Type-1 Single-Panel Codebooks for 5G NR defined in Section 5.2.2.2.1 of 3GPP TS 38.214 will result in a transmit power imbalance for DMRS across the transmit antennas, and the transmit power for DMRS symbols will be higher (for example, 2-3 dB) compared to that for data symbols. This has also been observed in testing for an example 4×4 MIMO system.

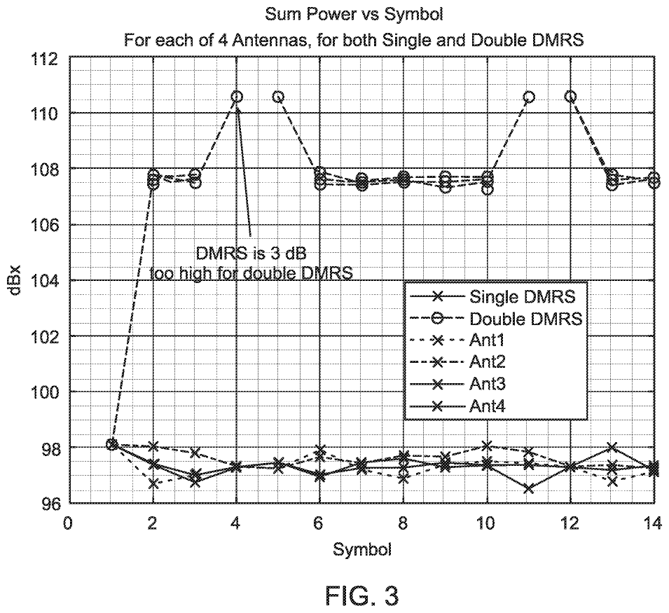

FIG. 3 includes a graph 300 that depicts the transmit power per symbol of four transmit antennas for single-symbol DMRS (shown as “Single DMRS” in FIG. 3) and for double-symbol DMRS (shown as “Double DMRS” in FIG. 3) for an example 4×4 MIMO configuration. Each data point in the graph represents the average power at a particular antenna for a particular symbol. In the example shown in FIG. 3, the symbols 4-5 and 11-12 are used for DMRS, and symbols 1-3, 6-10, and 13-14 are used for data.

As shown in FIG. 3, for single-symbol DMRS, the transmit power is relatively consistent across the antennas for each of the symbols, whether used for data or DMRS. However, as shown in FIG. 3, for double-symbol DMRS, the transmit power for DMRS is approximately 3 dB higher than the transmit power for data, and there is an imbalance among the transmit power of the antennas for DMRS symbols. In the example shown in FIG. 3, during symbols 4 and 11, the transmit power of antenna 1 and antenna 2 increases approximately 3 dB above the transmit power for data, and the transmit power at antenna 3 and antenna 4 effectively goes to zero. Similarly, as shown in FIG. 3, during symbols 5 and 12, the transmit power of antenna 3 and antenna 4 increases approximately 3 dB above the transmit power for data, and the power at antenna 1 and antenna 2 effectively goes to zero. These captures of transmit signals verify the analysis discussed above with respect to FIGS. 2A-2C.

Transmit chains for base stations are typically designed (for example, linear range and/or max power of power amplifier selected, etc.) to accommodate the transmit power for data symbols. If the transmit chain of the 4×4 MIMO configuration discussed with respect to FIG. 3 is not adjusted to accommodate the increase in transmit power for DMRS compared to the transmit power for data, it can lead to signal distortion and an increase in Block Error Rate (BLER) because the peak transmit power for DMRS would extend outside the linear range and/or max power of the power amplifier. If the transmit chain is adjusted to accommodate the peak transmit power for DMRS by operating at a lower transmit power for data (for example, −3 dB), then this would lead to a loss of 3 dB in signal-to-interference-plus-noise ratio (SINR) performance. If the transmit chain is adjusted to accommodate the peak transmit power for DMRS by utilizing a power amplifier with a higher linear range and/or max power, which would need to be linear well beyond what is required in 3GPP specifications, this could significantly increase the costs for implementing the base station.

In order to address the above referenced problems related to transmit power imbalance for DMRS, the base station 10, 100, 150 is configured to use one or more codebooks for DMRS that have been modified such that the problems discussed above are addressed without a reduction or change in performance for the UEs 108. The one or more modified codebooks 18 used by the base station 10, 100, 150 when executing a precoding function 16 are modified versions of the codebooks defined in a 3GPP specification. In some examples, the modified codebooks 18 are generated offline and stored in a memory of the base station 10, 100, 150, and the base station 10, 100, 150 is configured to retrieve the modified codebook 18 from memory prior to applying the modified precoder when executing a precoding function 16. In some such examples, the modified codebooks 18 are stored in a look-up table. In other examples, the modified codebooks 18 are generated at run-time and in response to the requested precoder from the UE 108.

Each modified codebook 18 includes one or more columns that are identical to corresponding columns in the codebook defined in the 3GPP specification. In some examples, each modified codebook 18 includes one or more additional columns that have values with the same magnitude as corresponding columns in the codebook defined in the 3GPP specification, but the values are multiplied by a unit magnitude constant. In some examples, each modified codebook includes one or more additional columns that have values with the same magnitude as corresponding columns in the codebook defined in the 3GPP specification, but the values are multiplied by j.

The base stations 10, 100, 150 described herein are configured to apply a modified precoder from a modified codebook 18 to a double-symbol DMRS rather than applying the requested precoder from the UE 108 that is defined in Section 5.2.2.2 of 3GPP TS 38.214. The base stations 10, 100, 150 are then configured to transmit the double-symbol DMRS with the modified precoder to the UE 108.

The particular component of the base station 10, 100, 150 configured to execute the precoding function 16 and apply the modified precoder from the modified codebook 18 depends on the functional split option implemented by the base station 10, 100, 150.

In some examples of the gNB 10 shown in FIG. 1A, the CU 12 is configured to execute the precoding function 16 and apply the modified precoder from the modified codebook 18 when the CU 12 includes the “High” Physical Layer functionality of the 5G NR protocol stack (for example, Option 7 or Option 8 in TR 38.801). In some examples of the gNB 10 shown in FIG. 1A, at least one DU 14 is configured to execute the precoding function 16 and apply the modified precoder from the modified codebook 18 when the DU 14 includes the “High” Physical Layer functionality of the 5G NR protocol stack (for example, Options 1-6 in TR 38.801). It should be understood that the particular functional split can be different for each DU 14.

In some examples of the base stations 100, 150 shown in FIGS. 1B-1C, the DU 105 is configured to execute the precoding function 16 and apply the modified precoder from the modified codebook 18 when the DU 105 includes the “High” Physical Layer functionality of the 5G NR protocol stack (for example, Option 7.2 or Option 8). In some examples of the base stations 100, 150 shown in FIGS. 1B-1C, at least one RU 106 is configured to execute the precoding function 16 and apply the modified precoder from the modified codebook 18 when the RU 106 includes the “High” Physical Layer functionality of the 5G NR protocol stack (for example, Option 6). While not shown in FIGS. 1B-1C, it should be understood that the CU 103 can also be configured to execute the precoding function 16 and apply the modified precoder when the CU 103 includes the “High” Physical Layer functionality of the 5G NR protocol stack. It should be understood that the particular functional split can be different for each CU 103, DU 105, and RU 106.

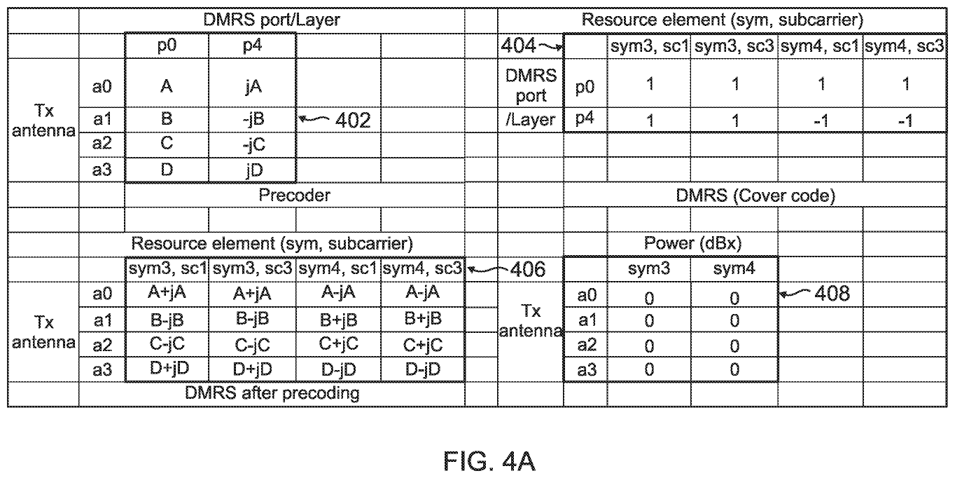

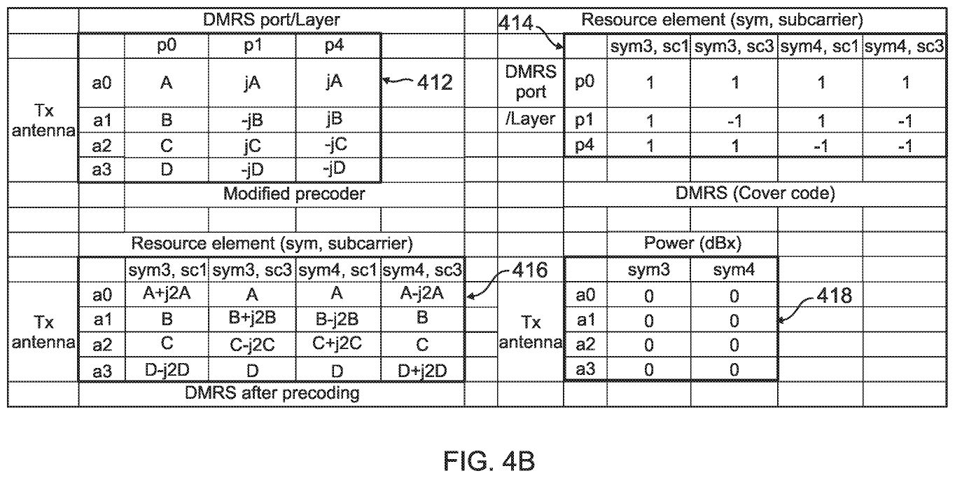

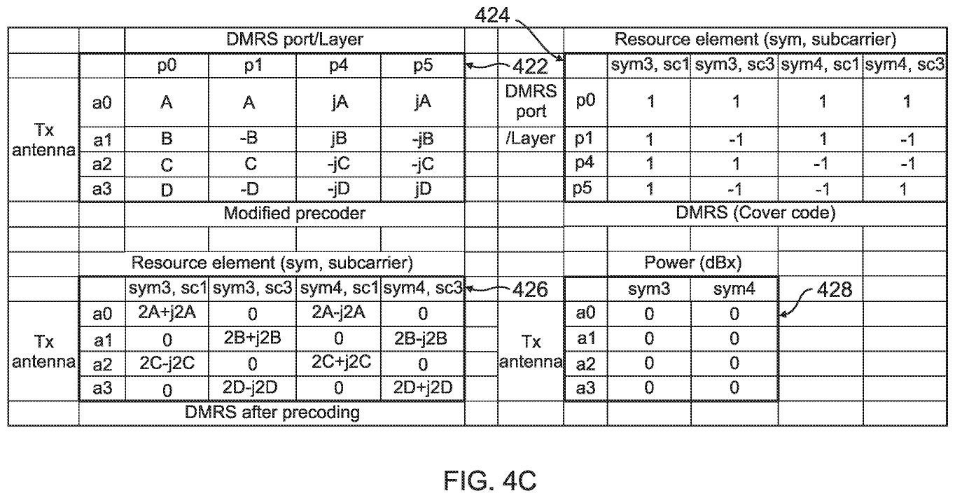

FIGS. 4A-4C illustrate the precoder matrix (P), DMRS cover codes (C), DMRS after precoding, and transmit power of antennas for example 4×L (L=2,3,4) MIMO systems using the modified codebooks discussed above.

FIG. 4A illustrates the modified precoder matrix 402, DMRS cover codes 404, DMRS after precoding 406, and transmit power of antennas 408 for an example 4×2 MIMO system using the modified codebook. In the example shown in FIG. 4A, the form of the modified precoder matrix 402 is shown, and the letters A, B, C, and D in the modified precoder matrix 402 represent different values from the 2-layer modified codebook. In the example shown in FIG. 4A, the first column of the modified precoder matrix 402 is identical to the first column of the 2-layer codebook shown in FIG. 2A. The second column in the modified precoder matrix 402 includes the same values as the second column of the 2-layer codebook shown in FIG. 2A, but these values are multiplied by j. The DMRS cover codes 404 shown in FIG. 4A correspond to the DMRS cover codes 204 shown in FIG. 2A. The DMRS after precoding 406 represents the product of the modified precoder matrix 402 and the DMRS cover codes 404. As shown in the DMRS after precoding 406, columns 1-4 of the DMRS cover codes 404 are relatively coherent with rows 1-4 of the modified precoder matrix 402 and notably not orthogonal or relatively incoherent with any rows of the modified precoder matrix 402. By using the modified precoder matrix 402 shown in FIG. 4A, the transmit power for all of the antennas in the 4×2 MIMO system is equal in symbol 3 and symbol 4 as shown in the transmit power of antennas 408.

FIG. 4B illustrates the modified precoder matrix 412, DMRS cover codes 414, DMRS after precoding 416, and transmit power of antennas 418 for an example 4×3 MIMO system using the modified codebook. In the example shown in FIG. 4B, the form of the modified precoder matrix 412 is shown, and the letters A, B, C, and D in the modified precoder matrix 412 represent different values from the 3-layer modified codebook. In the example shown in FIG. 4B, the first column of the modified precoder matrix 412 is identical to the first column of the 3-layer codebook shown in FIG. 2B. The second column and the third column in the modified precoder matrix 412 include the same values as the second column and the third column of the 3-layer codebook shown in FIG. 2B, but these values are multiplied by j. The DMRS cover codes 414 shown in FIG. 4B correspond to the DMRS cover codes 214 shown in FIG. 2B. The DMRS after precoding 416 represents the product of the modified precoder matrix 412 and the DMRS cover codes 414. As shown in the DMRS after precoding 416, columns 1-4 of the DMRS cover codes 414 are relatively coherent with rows 1-4 of the modified precoder matrix 412 and notably not orthogonal or relatively incoherent with any rows of the modified precoder matrix 412. By using the modified precoder matrix 412 shown in FIG. 4B, the transmit power for all of the antennas in the 4×3 MIMO system is equal in symbol 3 and symbol 4 as shown in the transmit power of antennas 418.

FIG. 4C illustrates the modified precoder matrix 422, DMRS cover codes 424, DMRS after precoding 426, and transmit power of antennas 428 for an example 4×4 MIMO system using the modified codebook. In the example shown in FIG. 4C, the form of the modified precoder matrix 422 is shown, and the letters A, B, C, and D in the modified precoder matrix 422 represent different values from the 4-layer modified codebook. In the example shown in FIG. 4C, the first column and the second column of the modified precoder matrix 422 are identical to the first column and the second column of the 4-layer codebook shown in FIG. 2C, respectively. The third column and the fourth column in the modified precoder matrix 422 include the same values as the third column and the fourth column of the 4-layer codebook shown in FIG. 2B, respectively, but these values are multiplied by j. The DMRS cover codes 424 shown in FIG. 4C correspond to the DMRS cover codes 214 shown in FIG. 2C. The DMRS after precoding 426 represents the product of the modified precoder matrix 422 and the DMRS cover codes 424. As shown in the DMRS after precoding 426, columns 1-4 of the DMRS cover codes 424 are relatively coherent with rows 1-4 of the modified precoder matrix 422 and notably not orthogonal or relatively incoherent with any rows of the modified precoder matrix 422. By using the modified precoder matrix 412 shown in FIG. 4C, the transmit power for all of the antennas in the 4×4 MIMO system is equal in symbol 3 and symbol 4 as shown in the transmit power of antennas 428.

As discussed above, even if the base station uses the modified codebooks 18, the UEs 108 will specify a preferred PMI based on the original 5G codebooks. Analysis was conducted to determine whether there would be degradation of performance if the base station 10, 100, 150 uses a corresponding PMI for the modified codebook instead (apart from considerations of the distortion mentioned above associated with transmission using the 5G codebook). With transmission from the original codebook, the 4×1 reception at the UE is:

r=HPs+n,

where H is the 4×4 channel matrix, s is a v×1 vector containing the data symbols, and n is a 4×1 vector representing noise plus interference at the UE antennas having covariance matrix Ψ=E[nn′]. Let \tilde{H}=HP represent the effective channel matrix in what follows. The estimate ŝ for s is obtained as:

ŝ=G′r,

Letting g^{(k)} represent the kth column of G, we have:

[symbol]

=g^{(k)}′r

for the estimate of the data symbol sent on the kth layer. The estimate error is eₖ= [symbol] −sₖ, and the mean squared error is:

$$E {\vert {e}_{k} \vert}^{2} = E [ ( {g}^{{( k )}^{′}} r - {s}_{k} ) {( {g}^{{( k )}^{′}} r - {s}_{k} )}^{′} ] = {g}^{{( k )}^{′}} {Ag}^{( k )} + 1 - {g}^{( k ) ′} {\tilde{h}}^{( k )} - {\tilde{h}}^{( k ) ′} {g}^{( k )} ,$$

where \tilde{h}(k) represents the kth column of \tilde{H}, and

$$A = Ψ + \tilde{H} {\tilde{H}}^{′} = Ψ + {\sum }_{k} {\tilde{h}}^{( k )} {\tilde{h}}^{{( k )}^{′}} .$$

The minimum mean squared error solution is:

g^{(k)}=A⁻¹\tilde{h}^{(k)},

and the corresponding minimum mean squared error is:

E|eₖ|²=1−\tilde{h}^{(k)}′A⁻¹\tilde{h}^{(k)}.

When the codebook is modified, \tilde{h}^{(k)}=Hp^{(k)} is unchanged or is multiplied by j, so A is unchanged with the codebook modification. Furthermore, multiplying \tilde{h}^{(k)} by j has no impact on E|eₖ|², so the minimum mean squared error is the same when transmitting from the modified codebook as transmitting from the 5G codebook. Note also that if the UE scales g^{(k)} for unbiased estimates as:

g^{(k)}=A⁻¹\tilde{h}^{(k)}/(\tilde{h}^{(k)}′A⁻¹\tilde{h}^{(k)}),

then the mean squared error is still the same for the two codebooks.

Based on the above analysis, it has been determined that there is no expected loss in performance (even when not factoring in any improvement due to the resolution of the DMRS power issue) when the precoder requested by the UE 108 is modified in a manner discussed above, and used for downlink transmission, compared to using the unmodified precoder requested by the UE 108.

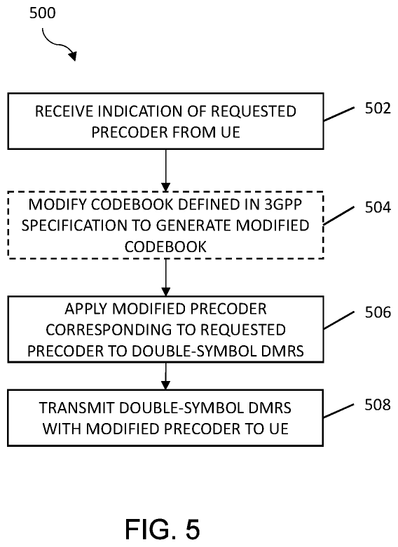

FIG. 5 illustrates a flow diagram of an example method 500 of preventing power imbalance across antennas for DMRS transmissions. The common features discussed above with respect to FIGS. 1A-1C and 4A-4C can include similar characteristics to those discussed with respect to method 500 and vice versa. In some examples, the method 500 is performed by one or more components of a base station (for example, base station 10, 100, 150).

The method 500 includes receiving an indication of a requested precoder from a UE (block 502). In some examples, the requested precoder is included in a codebook defined in a 3GPP specification. In some such examples, the requested precoder is included in a Type-1 Single-Panel codebook in 3GPP TS 38.214. In some examples, the indication of the requested precoder is a PMI provided from the UE in a measurement report to the base station.

The method 500 optionally includes modifying a codebook defined in a 3GPP specification to generate a modified codebook in response to the received indication of the requested precoder (block 504). In some examples, modifying the codebook defined in the 3GPP specification includes multiplying at least one column of the codebook defined in the 3GPP specification by a unit magnitude constant. In some examples, modifying the codebook defined in the 3GPP specification includes multiplying at least one column of the codebook defined in the 3GPP specification by j.

The method 500 further includes applying a modified precoder corresponding to the requested precoder to double-symbol DMRS (block 506) and transmitting DMRS with the modified precoder to the UE (block 508). In some examples, applying the modified precoder to double-symbol DMRS includes retrieving the modified precoder from a memory prior to applying the modified precoder. In some such examples, the modified precoder is stored in a look-up table. In some examples, the modified precoder corresponds to the modified precoders discussed above with respect to FIGS. 4A-4C.

Other examples are implemented in other ways.

The example techniques described herein prevent the power imbalance across antennas and corresponding peak-to-average ratio (PAR) issues when transmitting double-symbol DMRS using codebooks defined in 3GPP specifications. The systems and methods described herein enable higher transmit power levels for data and DMRS symbols while also avoiding distortion and BLER compared to current techniques because the peak transmit power for DMRS will fall within the linear range of a power amplifier designed for the peak transmit power for data. Further, the techniques described herein provide these benefits without a loss of performance for the UE compared to using the requested precoder even without factoring in the distortion mentioned above associated with transmission using the 5G codebooks defined in 3GPP TS 38.214.

While the problems described above involve 5G NR systems, it is to be understood the techniques described here can be used with other wireless interfaces and references to “gNB” can be replaced with the more general term “base station” or “base station entity” and/or a term particular to the alternative wireless interfaces. Furthermore, it is also to be understood that 5G NR embodiments can be used in both standalone and non-standalone modes (or other modes developed in the future), and the following description is not intended to be limited to any particular mode. Also, unless explicitly indicated to the contrary, references to “layers” or a “layer” (for example, Layer-1, Layer-2, Layer-3, the Physical Layer, the MAC Layer, etc.) set forth herein refer to layers of the wireless interface (for example, 5G NR) used for wireless communication between a base station and user equipment.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

### Example Embodiments

Example 1 includes a method, comprising: receiving an indication of a requested precoder from a user equipment, wherein the requested precoder is included in a codebook defined in a 3rd Generation Partnership Project (3GPP) specification; applying a modified precoder corresponding to the requested precoder, wherein the modified precoder is included in a modified codebook that is a modified version of the codebook defined in the 3GPP specification; and transmitting a double-symbol demodulation reference signal with the modified precoder to the user equipment.

Example 2 includes the method of Example 1, further comprising modifying the codebook defined in the 3GPP specification to generate the modified codebook.

Example 3 includes the method of any of Examples 1-2, wherein the modified codebook includes at least one column of the codebook defined in the 3GPP specification multiplied by a unit magnitude constant.

Example 4 includes the method of any of Examples 1-3, wherein the modified codebook includes at least one column of the codebook defined in the 3GPP specification multiplied by j.

Example 5 includes the method of any of Examples 1-4, wherein the codebook defined in the 3GPP specification is a Type 1 Single-Panel Codebook.

Example 6 includes the method of any of Examples 1-5, further comprising retrieving the modified precoder from a look-up table prior to applying the modified precoder.

Example 7 includes the method of any of Examples 1-6, further comprising generating the modified precoder in response to the indication of the requested precoder from the user equipment.

Example 8 includes the method of any of Examples 1-7, wherein applying the modified precoder causes transmit power to be balanced equally across multiple antennas for each demodulation reference signal symbol.

Example 9 includes a system, comprising: a base station configured to provide service to user equipment in a cell, wherein the base station is configured to: receive an indication of a requested precoder from a first user equipment in the cell, wherein the requested precoder is included in a codebook defined in a 3rd Generation Partnership Project (3GPP) specification; apply a modified precoder corresponding to the requested precoder to a double-symbol demodulation reference signal, wherein the modified precoder is included in a modified codebook that is a modified version of the codebook defined in the 3GPP specification; and transmit the double-symbol demodulation reference signal with the modified precoder to the first user equipment.

Example 10 includes the system of Example 9, wherein the base station is further configured to modify the codebook defined in the 3GPP specification to generate the modified codebook.

Example 11 includes the system of Example 10, wherein the codebook defined in the 3GPP specification is a Type 1 Single-Panel Codebook.

Example 12 includes the system of any of Examples 9-11, wherein the modified codebook that is a modified version of the codebook defined in the 3GPP specification is stored in a memory, wherein the base station is configured to retrieve the modified precoder from the memory prior to applying the modified precoder.

Example 13 includes the system of any of Examples 9-12, wherein the modified codebook is used for 4×2 multiple-input-multiple-output (MIMO) signals and includes a first column and a second column, wherein the first column is identical to a first column of the codebook defined in the 3GPP specification, wherein the second column includes values of a second column of the codebook defined in the 3GPP specification multiplied by j.

Example 14 includes the system of any of Examples 9-13, wherein the modified codebook is used for 4×3 multiple-input-multiple-output (MIMO) signals and includes a first column, a second column, and a third column; wherein the first column is identical to a first column of the codebook defined in the 3GPP specification, wherein the second column includes values of a second column of the codebook defined in the 3GPP specification multiplied by j, wherein the third column includes values of a third column of the codebook defined in the 3GPP specification multiplied by j.

Example 15 includes the system of any of Examples 9-14, wherein the modified codebook is used for 4×4 multiple-input-multiple-output (MIMO) signals and includes a first column, a second column, a third column, and a fourth column; wherein the first column is identical to a first column of the codebook defined in the 3GPP specification, wherein the second column is identical to a second column of the codebook defined in the 3GPP specification, wherein the third column includes values of a third column of the codebook defined in the 3GPP specification multiplied by j, wherein the fourth column includes values of a fourth column of the codebook defined in the 3GPP specification multiplied by j.

Example 16 includes the system of any of Examples 9-15, wherein the base station includes a central unit communicatively coupled to one or more distributed units, wherein the central unit is configured to apply the modified precoder corresponding to the requested precoder to the double-symbol demodulation reference signal.

Example 17 includes the system of any of Examples 9-16, wherein the base station includes a central unit communicatively coupled to one or more distributed units, wherein the one or more distributed units are configured to apply the modified precoder corresponding to the requested precoder to the double-symbol demodulation reference signal.

Example 18 includes the system of any of Examples 9-17, wherein the base station comprises one or more radio units communicatively coupled to one or more distributed units, wherein the one or more radio units are configured to transmit the double-symbol demodulation reference signal with the modified precoder to the first user equipment.

Example 19 includes the system of any of Examples 9-18, wherein the base station includes a central unit communicatively coupled to one or more distributed units and one or more radio units communicatively coupled to the one or more distributed units, wherein the one or more radio units are configured to apply the modified precoder corresponding to the requested precoder to the double-symbol demodulation reference signal, wherein the one or more radio units are configured to transmit the double-symbol demodulation reference signal with the modified precoder to the first user equipment.

Example 20 includes the system of any of Examples 9-19, wherein the modified precoder causes transmit power to be balanced equally across multiple antennas for each demodulation reference signal symbol.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A method, comprising:
receiving an indication of a requested precoder from a user equipment, wherein the requested precoder is included in a codebook defined in a 3rd Generation Partnership Project (3GPP) specification;
applying a modified precoder corresponding to the requested precoder, wherein the modified precoder is included in a modified codebook that is a modified version of the codebook defined in the 3GPP specification; and
transmitting a double-symbol demodulation reference signal with the modified precoder to the user equipment.

2. The method of claim 1, further comprising modifying the codebook defined in the 3GPP specification to generate the modified codebook.

3. The method of claim 1, wherein the modified codebook includes at least one column of the codebook defined in the 3GPP specification multiplied by a unit magnitude constant.

4. The method of claim 1, wherein the modified codebook includes at least one column of the codebook defined in the 3GPP specification multiplied by j.

5. The method of claim 1, wherein the codebook defined in the 3GPP specification is a Type 1 Single-Panel Codebook.

6. The method of claim 1, further comprising retrieving the modified precoder from a look-up table prior to applying the modified precoder.

7. The method of claim 1, further comprising generating the modified precoder in response to the indication of the requested precoder from the user equipment.

8. The method of claim 1, wherein applying the modified precoder causes transmit power to be balanced equally across multiple antennas for each demodulation reference signal symbol.

9. A system, comprising:
a base station configured to provide service to user equipment in a cell, wherein the base station is configured to:
receive an indication of a requested precoder from a first user equipment in the cell, wherein the requested precoder is included in a codebook defined in a 3rd Generation Partnership Project (3GPP) specification;
apply a modified precoder corresponding to the requested precoder to a double-symbol demodulation reference signal, wherein the modified precoder is included in a modified codebook that is a modified version of the codebook defined in the 3GPP specification; and
transmit the double-symbol demodulation reference signal with the modified precoder to the first user equipment.

10. The system of claim 9, wherein the base station is further configured to modify the codebook defined in the 3GPP specification to generate the modified codebook.

11. The system of claim 10, wherein the codebook defined in the 3GPP specification is a Type 1 Single-Panel Codebook.

12. The system of claim 9, wherein the modified codebook that is a modified version of the codebook defined in the 3GPP specification is stored in a memory, wherein the base station is configured to retrieve the modified precoder from the memory prior to applying the modified precoder.

13. The system of claim 9, wherein the modified codebook is used for 4×2 multiple-input-multiple-output (MIMO) signals and includes a first column and a second column, wherein the first column is identical to a first column of the codebook defined in the 3GPP specification, wherein the second column includes values of a second column of the codebook defined in the 3GPP specification multiplied by j.

14. The system of claim 9, wherein the modified codebook is used for 4×3 multiple-input-multiple-output (MIMO) signals and includes a first column, a second column, and a third column;
wherein the first column is identical to a first column of the codebook defined in the 3GPP specification, wherein the second column includes values of a second column of the codebook defined in the 3GPP specification multiplied by j, wherein the third column includes values of a third column of the codebook defined in the 3GPP specification multiplied by j.

15. The system of claim 9, wherein the modified codebook is used for 4×4 multiple-input-multiple-output (MIMO) signals and includes a first column, a second column, a third column, and a fourth column;
wherein the first column is identical to a first column of the codebook defined in the 3GPP specification, wherein the second column is identical to a second column of the codebook defined in the 3GPP specification, wherein the third column includes values of a third column of the codebook defined in the 3GPP specification multiplied by j, wherein the fourth column includes values of a fourth column of the codebook defined in the 3GPP specification multiplied by j.

16. The system of claim 9, wherein the base station includes a central unit communicatively coupled to one or more distributed units, wherein the central unit is configured to apply the modified precoder corresponding to the requested precoder to the double-symbol demodulation reference signal.

17. The system of claim 9, wherein the base station includes a central unit communicatively coupled to one or more distributed units, wherein the one or more distributed units are configured to apply the modified precoder corresponding to the requested precoder to the double-symbol demodulation reference signal.

18. The system of claim 9, wherein the base station comprises one or more radio units communicatively coupled to one or more distributed units, wherein the one or more radio units are configured to transmit the double-symbol demodulation reference signal with the modified precoder to the first user equipment.

19. The system of claim 9, wherein the base station includes a central unit communicatively coupled to one or more distributed units and one or more radio units communicatively coupled to the one or more distributed units, wherein the one or more radio units are configured to apply the modified precoder corresponding to the requested precoder to the double-symbol demodulation reference signal, wherein the one or more radio units are configured to transmit the double-symbol demodulation reference signal with the modified precoder to the first user equipment.

20. The system of claim 9, wherein the modified precoder causes transmit power to be balanced equally across multiple antennas for each demodulation reference signal symbol.
